(19) United States
(12) Patent Application Publication
(10) Pub. No.: US 2025/0247763 A1
(43) Pub. Date: Jul. 31, 2025

(54) USER EQUIPMENT AND SERVING CELL THAT PERFORM CONDITIONAL HANDOVER AND OPERATION METHOD THEREOF

(71) Applicant: Samsung Electronics Co., Ltd., Suwon-si (KR)

(72) Inventor: Yangsoo KWON, Suwon-si (KR)

(73) Assignee: Samsung Electronics Co., Ltd., Suwon-si (KR)

(21) Appl. No.: 19/018,536

(22) Filed: Jan. 13, 2025

(30) Foreign Application Priority Data
Jan. 25, 2024 (KR) 10-2024-0011852
Jun. 18, 2024 (KR) 10-2024-0079097

(51) Int. Cl. H04W 36/36; H04B 17/318; H04W 36/00

(52) U.S. Cl. CPC H04W 36/362; H04B 17/328; H04W 36/0058; H04W 36/008357

(57) ABSTRACT

Provided is an operation method of user equipment, the operation method including transmitting a first message including assistance information to a serving cell based on a determination, the assistance information corresponding to a conditional handover, receiving a conditional handover-related message indicating adjusted first conditions, the adjusted first conditions having been adjusted from first conditions based on the assistance information, and the first conditions being conditions for performing a conditional handover, evaluating the adjusted first conditions to obtain an evaluation result, and performing the conditional handover with a target cell based on the evaluation result.

### CROSS-REFERENCE TO RELATED APPLICATION

This application is based on and claims priority under 35 U.S.C. § 119 to Korean Patent Application Nos. 10-2024-0011852, filed on Jan. 25, 2024, and 10-2024-0079097, filed on Jun. 18, 2024, in the Korean Intellectual Property Office, the disclosures of which are incorporated by reference herein in their entireties.

### BACKGROUND

The inventive concepts relate to user equipment and a serving cell that perform conditional handover, and an operation method thereof.

Recently, handover has been supported by next-generation communication systems, such as the 5G (5^{th} generation) system, to ensure (or improve) user mobility. Through handovers, users receive uninterrupted communication services even while moving. However, particularly when the handover is not performed smoothly, the amount of data lost due to the high frequency characteristics of the 5G system is very large. Thus, various methods to effectively perform handover are being studied.

As one of these methods, conditional handover-related technology has been proposed. Conditional handover helps to ensure that the user equipment is smoothly connected from a serving cell to a target cell by separating preparation and execution stages of handover.

In a conditional handover, a network may convey the configuration required (or to be used) for conditional handover to the user equipment through the serving cell while the user equipment experiences favorable radio conditions with the serving cell. When a candidate cell has a sufficiently good radio signal quality based on the configuration, the user equipment may determine the candidate cell as the target cell and perform handover to the target cell, thereby optimizing (or improving) the handover process for the user equipment and minimizing (or reducing) communication interruption.

In conditional handover-related technology, various methods to effectively perform conditional handover are being studied.

### SUMMARY

The inventive concepts provide user equipment generating and providing assistance information to assist conditional handover to a serving cell; the serving cell adjusting conditions for conditional handover based on the assistance information and notifying the user equipment of the adjusted conditions for conditional handover; and an operation method thereof.

According to an aspect of the inventive concepts, there is provided an operation method of user equipment, the operation method including transmitting a first message including assistance information to a serving cell based on a determination, the assistance information corresponding to a conditional handover, receiving a conditional handover-related message indicating adjusted first conditions, the adjusted first conditions having been adjusted from first conditions based on the assistance information, and the first conditions being conditions for performing a conditional handover, evaluating the adjusted first conditions to obtain an evaluation result, and performing the conditional handover with a target cell based on the evaluation result.

According to an aspect of the inventive concepts, there is provided an operation method of a serving cell, the operation method including receiving a first message including assistance information from user equipment, the assistance information corresponding to a conditional handover, adjusting first conditions based on the assistance information to obtain adjusted first conditions, the first conditions being conditions for performing a conditional handover, and transmitting a conditional handover-related message indicating the adjusted first conditions.

According to an aspect of the inventive concepts, there is provided user equipment including memory configured to store assistance information for relaxing or strengthening conditions for conditional handover, and a processor configured to determine whether to transmit the assistance information to a serving cell based on an index value of reception performance, the index value being generated by measuring a data reception rate and a received signal strength from signals received from the serving cell.

### BRIEF DESCRIPTION OF THE DRAWINGS

Embodiments will be more clearly understood from the following detailed description taken in conjunction with the accompanying drawings in which:

FIG. 1 is a diagram of a communication system according to embodiments;

FIG. 2 is a schematic block diagram of user equipment according to embodiments;

FIG. 3 is a flowchart of an operation method of user equipment and a serving cell, according to embodiments;

FIGS. 4A to 4C are flowcharts of specific examples of operation S100 in FIG. 3;

FIG. 5 is a flowchart of an operation method of user equipment, according to embodiments;

FIG. 6 is a diagram of assistance information, according to embodiments;

FIGS. 7A to 7C are diagrams specifically explaining examples of adjusting conditions for conditional handover related to an event “A3”, according to embodiments;

FIGS. 8A and 8B are flowcharts of a method of transmitting assistance information, according to embodiments;

FIG. 9 is a flowchart of a method of transmitting assistance information, according to embodiments;

FIG. 10 is a flowchart of a method of transmitting assistance information, according to embodiments;

FIG. 11 is a flowchart of a conditional handover operation according to embodiments;

FIG. 12 is a block diagram of an electronic device according to embodiments; and

FIG. 13 is a diagram of communication devices performing a conditional handover operation according to embodiments.

### DETAILED DESCRIPTION

Hereinafter, embodiments are described in detail with reference to the attached drawings.

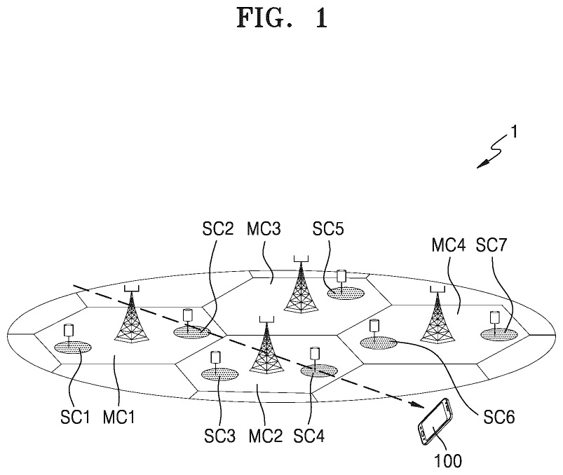

FIG. 1 is a diagram of a communication system 1 according to embodiments. The inventive concepts are applicable to both a homogeneous network composed of the same type of cells (or similar types of cells) and a heterogeneous network composed of different types of cells. The communication system 1 may be mainly described based on a 5th generation (5G) system configured to support conditional handover but this is just a non-limiting example and embodiments are not limited thereto. The communication system 1 may correspond to any one of various types of network systems configured to support the conditional handover.

In addition, various functions described below may be implemented or supported by artificial intelligence technology and/or one or more computer programs, each of which is configured with computer-readable program code and executed on a non-transitory computer-readable medium. The terms “application” and “program” refer to one or more computer programs, software components, instruction sets, procedures, functions, objects, classes, instances, related data, or portions thereof suitable for implementation of suitable computer-readable program code. The term “computer readable program code” includes all types of computer code, including source code, object code, and executable code. The term “computer-readable medium” includes any type of medium that may be accessed by a computer, such as read-only memory (ROM), random-access memory (RAM), a hard disk drive, a compact disc (CD), a digital video disc (DVD), or other types of memory. A “non-transitory” computer-readable medium excludes wired, wireless, optical, or other communication links that transmit transitory electrical or other signals. The non-transitory computer-readable medium includes a medium in which data may be permanently stored, and a medium in which data may be stored and later overwritten, such as a rewritable optical disk or an erasable memory device.

In embodiments to be described below, a hardware approach is used as an example. However, embodiments do not exclude a software approach (in which the software is executed by corresponding hardware) because embodiments include technologies using both hardware and software.

Referring to FIG. 1, the communication system 1 may include a plurality of macro cells MC1 to MC4, a plurality of small cells SC1 to SC7, and/or user equipment 100. The user equipment 100, as a wireless communication device, may be mobile and may communicate with the plurality of macro cells MC1 to MC4 and/or the plurality of small cells SC1 to SC7 to transmit and receive data and/or control information. The user equipment 100 may be referred to as, for example, a terminal, a mobile station (MS), a mobile terminal (MT), a user terminal, a subscriber station (SS), a wireless device, a hand-held device, a communication device, and the like.

The plurality of macro cells MC1 to MC4 and the plurality of small cells SC1 to SC7 may generally refer to fixed stations in communication with the user equipment 100 and/or another cell and may exchange the data and control information by communicating with the user equipment 100 and/or the other cell. The plurality of macro cells MC1 to MC4 may correspond to a larger coverage area than the plurality of small cells SC1 to SC7. The coverage area refers to a range in which a given cell may provide a network to a user (or user equipment).

The plurality of macro cells MC1 to MC4 and the plurality of small cells SC1 to SC7 may each be referred to as, e.g., a base station, a Node B, an evolved-Node B (eNB), a sector, a site, a base transceiver system (BTS), an access point (AP), a relay node, a remote radio head (RRH), a radio unit (RU), and the like. Although the communication system 1 of FIG. 1 includes only the plurality of macro cells MC1 to MC4 and the plurality of small cells SC1 to SC7 corresponding to different coverage areas, this is only an example and not limited thereto. The communication system 1 may further include a mega-cell, a micro-cell, a pico-cell, and a femto-cell, corresponding to coverage areas of various sizes.

The mobility of the user equipment 100 may result in handover from a macro cell to a macro cell, from a macro cell to a small cell, from a small cell to a macro cell, or from a small cell to a small cell. For conditional handover, a conditional handover procedure specified in 3rd generation partnership project (3GPP) standards may be performed between the user equipment 100, a serving cell, and a target cell. Herein, the serving cell may be defined as a cell that is currently connected with the user equipment 100 to provide a communication network and the target cell may be defined as a cell selected as a handover target among candidate cells adjacent (or nearby) to the serving cell.

According to embodiments, the user equipment 100 may determine whether to transmit assistance information to the serving cell to assist the conditional handover, based on the reception performance of the user equipment 100 or the history of a previous conditional handover(s). Herein, the assistance information may include information generated by the user equipment 100 and referenced by the serving cell to adjust conditions for conditional handover.

According to embodiments, when the user equipment 100 determines to transmit the assistance information to the serving cell, the assistance information generated from the user equipment 100 may be transmitted to the serving cell prior to performing conditional handover with the serving cell and the target cell.

According to embodiments, the user equipment 100 may provide the assistance information to the serving cell by including the assistance information in one of messages (e.g., one of a plurality of messages) defined in 3GPP technical specification (TS) 38.331 and transmitted from the user equipment 100 to the serving cell.

In the following, examples relating to conditional handover based on the assistance information according to embodiments are outlined.

The user equipment 100 may receive a radio resource control (RRC) reconfiguration message including a measurement configuration from a serving cell which is currently RRC connected and provides a network service. The measurement configuration, which is a prior arrangement for the user equipment 100 to measure the signal received from the serving cell and transmit a measurement report to the serving cell, may include measurement object information to be measured by the user equipment 100 and report configuration. For example, the measurement object information may include a frequency band, candidate cell information, and/or a blacklist, and the report configuration may include information indicating specific events for which the user equipment 100 needs (or is configured, requested, etc.) to transmit the measurement report. At least one of the specific events may be associated with conditions for conditional handover.

The user equipment 100 may measure at least one received signal based on the measurement configuration received from the serving cell. Specifically, the user equipment 100 may measure at least one signal corresponding to the measurement object information included in the measurement configuration. The user equipment 100 may perform a measurement operation and periodically or aperiodically check whether an event corresponding to the measurement configuration occurs.

When a specific event occurs (e.g., in response to determining and/or detecting the specific event) while performing the measurement operation, the user equipment 100 may report a result (or a measurement result) of the measurement operation to the serving cell. Specifically, the user equipment 100 may transmit the measurement report including the result of the corresponding measurement operation to the serving cell in response to the occurrence of the specific event.

According to embodiments, the serving cell may determine the conditional handover according to the conditions adjusted by the assistance information based on the measurement report received from the user equipment 100. In addition, the serving cell may perform a preparation operation for conditional handover with the candidate cells.

According to embodiments, the serving cell may transmit a conditional handover command including information about the adjusted conditions to the user equipment 100.

According to embodiments, the user equipment 100 may evaluate the adjusted conditions for conditional handover in response to the conditional handover command and perform the remaining operations for the conditional handover based on the evaluation result.

The user equipment 100, according to embodiments, may actively reflect the reception performance of the user equipment 100 or the history of previous conditional handover when performing conditional handover by generating and providing the assistance information for adjusting the conditions for conditional handover from the user equipment 100 to the serving cell.

In the serving cell, according to embodiments, the user equipment 100 may be smoothly handed over to the target cell by adjusting the conditions for conditional handover based on the assistance information received from the user equipment 100. As a result, data loss due to the conditional handover may be minimized (or reduced), thereby increasing the efficiency of using wireless resources.

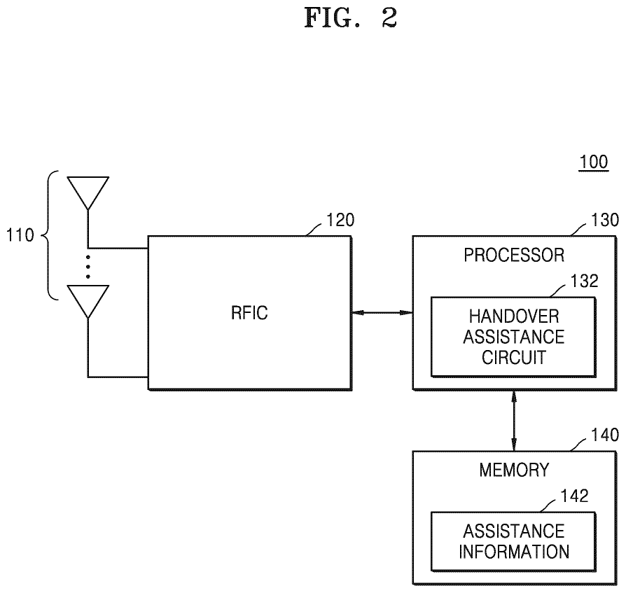

FIG. 2 is a schematic block diagram of the user equipment 100 according to embodiments.

Referring to FIG. 2, the user equipment 100 may include a plurality of antennas 110, a radio frequency (RF) integrated circuit 120, a processor (or a baseband processor) 130, and/or memory 140. The implementation example of the user equipment 100 shown in FIG. 2 is only illustrative and embodiments are not limited thereto. The user equipment 100 may include more components or fewer components.

The RF integrated circuit 120 may perform functions, such as band conversion and amplification of signals, to transmit and receive signals through a wireless channel by using the plurality of antennas 110. Specifically, the RF integrated circuit 120 may generate an RF signal by performing a digital-to-analog conversion operation and a frequency up-conversion operation on a baseband signal provided from the processor 130 and transmit the RF signal through the antennas 110. In addition, the RF integrated circuit 120 may generate the baseband signal by performing a frequency down-conversion operation and an analog-to-digital conversion operation on the RF signal received through the antennas 110 and provide the baseband signal to the processor 130.

For example, the RF integrated circuit 120 may include a transmission filter, a reception filter, a power amplifier, a low-noise amplifier, a mixer, an oscillator, a digital-to-analog converter (DAC), and/or an analog-to-digital converter (ADC). In addition, the RF integrated circuit 120 may further include a plurality of RF chains and may perform beamforming using the antennas 110. The RF integrated circuit 120 may adjust the phase and magnitude of each of the signals transmitted and received through the antennas 110 for beamforming. In addition, the RF integrated circuit 120 may perform multi-input multi-output (MIMO) and may receive multiple layers when performing the MIMO.

The processor 130 may control the overall operations of the user equipment 100. According to embodiments, the processor 130 may include a handover assistance circuit 132 that generates the assistance information for adjusting the conditions for conditional handover and determines whether to transmit the assistance information to the serving cell.

The memory 140 may store data, such as a basic program or an application program, for operating the user equipment 100. According to embodiments, the memory 140 may store assistance information 142 generated by the processor 130.

According to embodiments, the handover assistance circuit 132 may determine whether to transmit the assistance information 142 to the serving cell based on the reception performance of the user equipment 100. According to embodiments, the reception performance may be associated with a data reception rate that changes in real time according to the movement of the user equipment 100, the location of the user equipment 100 within the coverage of the serving cell, and the like. For example, the data reception rate may include at least one of a data throughput and/or a data error rate based on a block error rate (BLER) or a bit error rate (BER). Herein, the data reception rate may be defined as being better (e.g., higher) when the data error rate becomes lower or the data throughput becomes higher.

According to embodiments, the handover assistance circuit 132 may periodically or aperiodically measure the data reception rate and received signal strength to generate an index value of the reception performance. The handover assistance circuit 132 may determine whether to transmit the assistance information 142 based on the index value of the reception performance. For example, the received signal strength may include at least one of reference signals received power (RSRP), reference signal received quality (RSRQ), signal to interference plus noise ratio (SINR), received signal code power (RSCP), and/or received energy from pilot signal to noise density (EcN0).

As an example, in a first case in which the received signal strength measured for the signal received from the serving cell is small enough to require (or trigger) handover to the target cell that is one of the candidate cells adjacent to the serving cell (or the received signal strength is less than a reference strength) and the measured data reception rate is less than a data reception rate expected from the measured received signal strength, the generated index value of the reception performance may be less than a first threshold value. The handover assistance circuit 132 may determine to transmit the assistance information 142 to the serving cell (e.g., in response to determining that the generated index value of the reception performance is less than the first threshold value). Specifically, the user equipment 100 may determine, in the first case, to transmit the assistance information 142 for relaxing the conditions for conditional handover to the serving cell by confirming that the reception performance is lower than expected in communication with the current serving cell. The relaxing of the conditions for conditional handover may refer to adjusting the conditions so that the user equipment 100 may be more easily handed over to the target cell (e.g., conditions that are less stringent, or otherwise easier to satisfy or more likely to be satisfied).

As another example, in a second case in which the received signal strength measured for the signal received from the serving cell is small enough to require (or trigger) handover to the target cell that is one of the candidate cells adjacent to the serving cell (or the received signal strength is less than the reference strength) and the measured data reception rate is greater than the data reception rate expected from the measured received signal strength, the generated index value of the reception performance may exceed a second threshold value. The handover assistance circuit 132 may determine to transmit the assistance information 142 to the serving cell (e.g., in response to determining the generated index value of the reception performance exceeds the second threshold value). Specifically, the user equipment 100 may, in the second case, determine to transmit the assistance information 142 for strengthening the conditions for conditional handover to the serving cell by confirming that the reception performance is higher than expected in communication with the current serving cell. The strengthening of the conditions for conditional handover may refer to adjusting the conditions so that the user equipment 100 may be handed over to the target cell with more difficulty (e.g., conditions that are more stringent, or otherwise more difficult to satisfy or less likely to be satisfied).

According to embodiments, the handover assistance circuit 132 may determine whether to transmit the assistance information 142 to the serving cell based on the evaluation-related history of previous conditional handover of the user equipment 100. For example, the handover assistance circuit 132 may analyze the evaluation result from the previously performed conditional handover of the user equipment 100 to confirm whether the conditions for conditional handover need to (or should) be relaxed and may determine to transmit the assistance information 142 to the serving cell based on the confirmation result.

According to embodiments, the handover assistance circuit 132 may generate the assistance information 142 for adjusting the conditions for conditional handover. For example, the assistance information 142 may be generated based on the preset (or alternatively, given) information or the index value of the reception performance generated by the handover assistance circuit 132.

According to embodiments, the assistance information 142 may include information for relaxing or strengthening the conditions for conditional handover. The handover assistance circuit 132 may store the assistance information 142 in the memory 140 before transmitting the assistance information 142 to the serving cell.

The user equipment 100, according to embodiments, may actively perform handover necessary (or more efficient, to allow avoidance or reduction of loss of connection, etc.) for the user equipment 100 and minimize (or reduce) handover unnecessary (or less efficient) for the user equipment 100 by relaxing or strengthening the conditions for conditional handover, based on the reception performance of the user equipment 100 or the history of previous conditional handover.

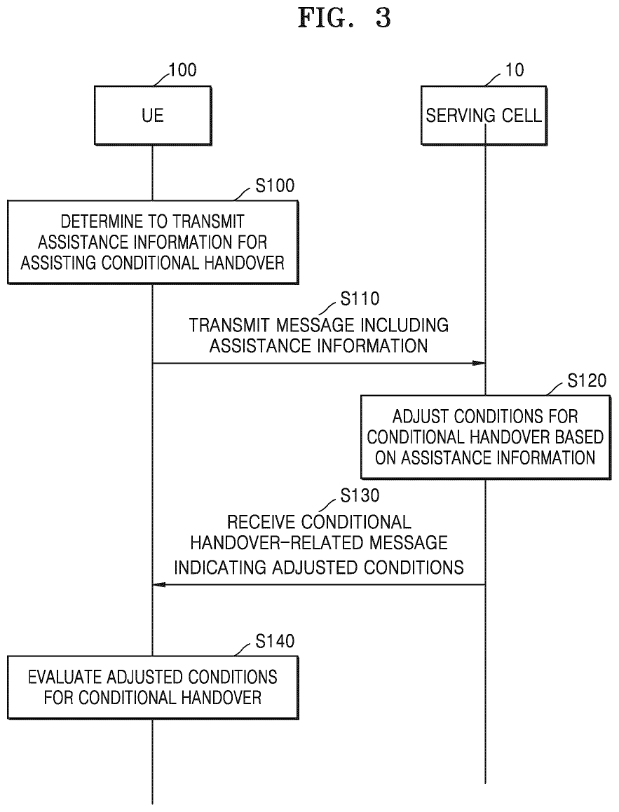

FIG. 3 is a flowchart of an operation method of the user equipment 100 and a serving cell 10, according to embodiments. Herein, the user equipment 100 may be referred to as UE.

Referring to FIG. 3, in operation S100, the user equipment 100 may determine to transmit assistance information for assisting conditional handover. According to embodiments, the user equipment 100 may periodically or aperiodically measure a data reception rate and/or a received signal strength to generate an index value of reception performance, and may determine whether to transmit the assistance information based on the generated index value.

In operation S110, the user equipment 100 may transmit a message (may also be referred to herein as a first message) including the assistance information. According to embodiments, the user equipment 100 may include the assistance information in any one of the messages defined in 3GPP TS 38.331 to provide the assistance information to the serving cell 10 via that message. That is, the user equipment 100 may transmit the assistance information to the serving cell 10 by following the message transmission and reception protocols defined in the 3GPP standard.

In operation S120, the serving cell 10 may adjust the conditions for conditional handover (may also be referred to herein as first conditions) based on the assistance information. For example, the conditions for conditional handover may be associated with at least one of the specific events for the measurement report described above with reference to FIG. 1. For example, the conditions for conditional handover may be associated with an event “A3” or an event “A5” and specific examples related thereto are described below.

In operation S130, the user equipment 100 may receive a conditional handover-related message indicating the adjusted conditions from the serving cell 10. In a specific example, the user equipment 100 may receive a conditional handover command from the serving cell 10 that includes the information indicating the adjusted conditions.

In operation S140, the user equipment 100 may evaluate the adjusted conditions for conditional handover. For example, the user equipment 100 may perform a measurement operation on signals received from the serving cell 10 and at least one of the candidate cells to evaluate whether the measurement result satisfies the adjusted conditions. The user equipment 100 may perform the remaining conditional handover procedure (e.g., the conditional handover procedure corresponding to the conditional handover-related messaged received in operation S130) with the target cell when the adjusted conditions are satisfied. The user equipment 100 may stop (e.g., skip, block, abort, etc.) the remaining conditional handover procedure when the adjusted conditions are not satisfied.

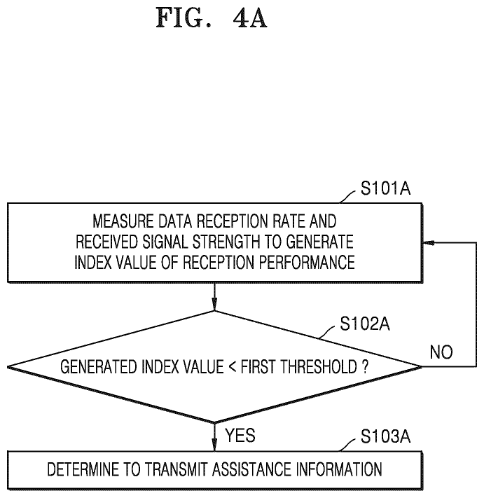

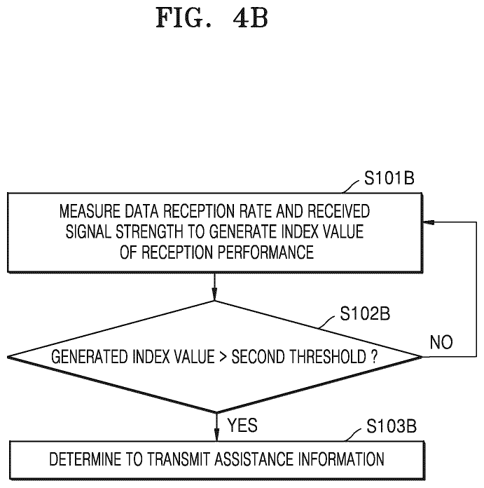

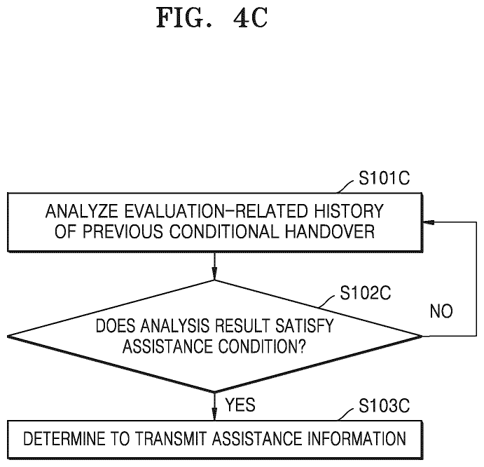

FIGS. 4A to 4C are flowcharts of specific examples of operation S100 in FIG. 3.

Referring to FIG. 4A, operation S100 in FIG. 3 may include operations S101A to S103A.

In operation S101A, the user equipment 100 may measure the data reception rate and/or the received signal strength to generate an index value of the reception performance. For example, the user equipment 100 may measure the data reception rate to periodically, or aperiodically generate the index value of the reception performance when the measured received signal strength is less than a reference strength. The reference strength may be preset to (or alternatively, given as) a strength at which the user equipment 100 is expected to require (or trigger) handover from the current serving cell to the target cell.

In operation S102A, the user equipment 100 may compare the index value generated in operation S101A with a first threshold to determine whether the generated index value is less than the first threshold.

When operation S102A is “YES”, the user equipment 100 may determine to transmit the assistance information in subsequent operation S103A. The assistance information may be intended to relax the conditions for conditional handover.

When operation S102A is “NO”, the user equipment 100 may perform operation S101A again.

With further reference to FIG. 4B, operation S100 in FIG. 3 may include operations S101B to S103B.

In operation S101B, the user equipment 100 may measure the data reception rate and/or the received signal strength to generate an index value of the reception performance.

In operation S102B, the user equipment 100 may compare the index value generated in operation S101B with a second threshold to determine whether the generated index value exceeds the second threshold.

When operation S102B is “YES”, the user equipment 100 may determine to transmit the assistance information in subsequent operation S103B. The assistance information may be intended to strengthen the conditions for conditional handover.

When operation S102B is “NO”, the user equipment 100 may perform operation S101B again.

With further reference to FIG. 4C, operation S100 of FIG. 3 may include operations S101C to S103C.

In operation S101C, the user equipment 100 may analyze the evaluation-related history of a previous conditional handover(s). For example, the user equipment 100 may analyze the evaluation result from at least one previously performed conditional handover to count a number of failures in which conditions for conditional handover are not satisfied due to a slight difference less than a threshold difference.

In operation S102C, the user equipment 100 may determine whether the analysis result of operation S101C satisfies an assistance condition. For example, the assistance condition may be set to a condition in which the number of failures counted in operation 101C exceeds a reference number.

When operation S102C is “YES”, the user equipment 100 may determine to transmit the assistance information in subsequent operation S103C. The assistance information may be intended to relax the conditions for conditional handover.

When operation S102C is “NO”, the user equipment 100 may perform operation S101C again.

However, embodiments described with reference to FIG. 4C are only illustrative and embodiments are not limited thereto. The user equipment 100 may analyze the evaluation-related history of previous conditional handover in various ways to determine whether to transmit the assistance information based on the analysis result.

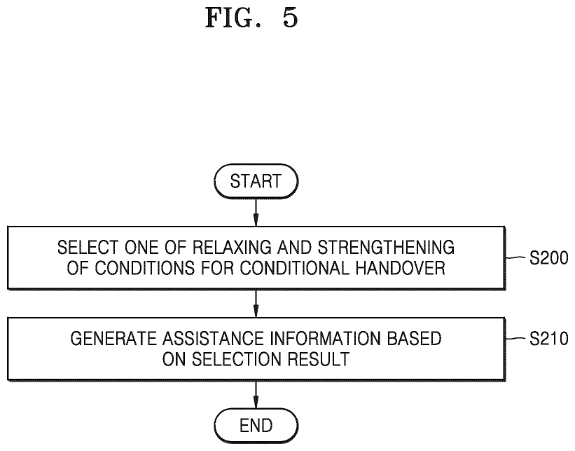

FIG. 5 is a flowchart of an operation method of user equipment, according to embodiments.

Referring to FIG. 5, in operation S200, the user equipment may select one of (e.g., select between) relaxing and strengthening of the conditions for conditional handover. According to embodiments, the user equipment may select one of relaxing and strengthening of the conditions for conditional handover based on the reception performance of the user equipment. According to embodiments, the user equipment may select one of relaxing and strengthening of the conditions for conditional handover based on the history of previous conditional handover of the user equipment.

In operation S210, the user equipment may generate the assistance information based on the selection result of operation S200. According to embodiments, when selecting one of relaxing and strengthening of the conditions for conditional handover, the user equipment may generate the assistance information referenced by the serving cell to relax the conditions for conditional handover. In addition, when selecting one of relaxing and strengthening of the conditions for conditional handover, the user equipment may generate the assistance information referenced by the serving cell to strengthen the conditions for conditional handover.

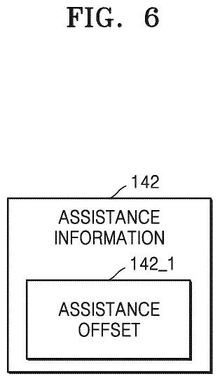

FIG. 6 is a diagram of assistance information 142, according to embodiments.

Referring to FIG. 6, the assistance information 142 may include an assistance offset 142_1. According to embodiments, the conditions for conditional handover may be set based on the event “A3” and/or the event “A5” for the measurement report. For example, the conditions for conditional handover may be set depending on whether an entering condition in the event “A3” or an entering condition in the event “A5” is satisfied.

According to embodiments, the event “A3” and the event “A5” included in the conditional handover may be defined as follows.

Inequality A3-1 (Entering condition)
Mn + Ofn + Ocn − Hys > Mp + Ofp + Ocp + Off − Of_a
Inequality A3-2 (Leaving condition)
Mn + Ofn + Ocn + Hys < Mp + Ofp + Ocp + Off − Of_a
The variables in the formula are defined as follows:
Mn is the measurement result of the neighbouring cell, not taking into account any offsets.
Ofn is the measurement object specific offset of the reference signal of the neighbour cell (e.g.,
offsetMO as defined within measObjectNR corresponding to the neighbour cell).
Ocn is the cell specific offset of the neighbour cell (e.g., cellIndividualOffset as defined within
measObjectNR corresponding to the frequency of the neighbour cell), and set to zero if not
configured for the neighbour cell.
Mp is the measurement result of the SpCell, not taking into account any offsets.
Ofp is the measurement object specific offset of the SpCell (e.g., offsetMO as defined within
measObjectNR corresponding to the SpCell).
Ocp is the cell specific offset of the SpCell (e.g., cellIndividualOffset as defined within
measObjectNR corresponding to the SpCell), and is set to zero if not configured for the SpCell.
Hys is the hysteresis parameter for this event (e.g., hysteresis as defined within reportConfigNR
for this event).
Off is the offset parameter for this event (e.g., a3-Offset as defined within reportConfigNR for
this event).
Of_a is the assistance offset for this event.
Mn, Mp are expressed in dBm in case of RSRP, or in dB in case of RSRQ and RS-SINR.
Ofn, Ocn, Ofp, Ocp, Hys, Off, Of_a are expressed in dB.
Inequality A5-1 (Entering condition 1)
Mp + Hys − Of_a< Thresh1
Inequality A5-2 (Entering condition 2)
Mn + Ofn + Ocn − Hys > Thresh2
Inequality A5-3 (Leaving condition 1)
Mp − Hys − Of_a > Thresh1
Inequality A5-4 (Leaving condition 2)
Mn + Ofn + Ocn + Hys < Thresh2
Mp is the measurement result of the NR SpCell, not taking into account any offsets.
Mn is the measurement result of the neighbouring cell, not taking into account any offsets.
Ofn is the measurement object specific offset of the neighbour cell (e.g., offsetMO as defined
within measObjectNR corresponding to the neighbour cell).
Ocn is the cell specific offset of the neighbour cell (e.g., cellIndividualOffset as defined within
measObjectNR corresponding to the neighbour cell), and set to zero if not configured for the
neighbour cell.
Hys is the hysteresis parameter for this event (e.g., hysteresis as defined within reportConfigNR
for this event).
Thresh1 is the threshold parameter for this event (e.g., a5-Threshold1 as defined within
reportConfigNR for this event).
Thresh2 is the threshold parameter for this event (e.g., a5-Threshold2 as defined within
reportConfigNR for this event).
Of_a is the assistance offset for this event.
Mn, Mp are expressed in dBm in case of RSRP, or in dB in case of RSRQ and RS-SINR.
Ofn, Ocn, Hys, and Of_a are expressed in dB.
Thresh1 is expressed in the same unit as Mp.
Thresh2 is expressed in the same unit as Mn.

For example, under an entering condition “A3-1” or a leaving condition “A3-2”, which is related to the event “A3”, “Mn” may be defined as a measurement result of a neighboring cell (or candidate cell) without considering any offsets, “Ofn” may be defined as a measurement object-specific offset of a reference signal of the neighboring cell (or candidate cell), and “Ocn” may be defined as a cell-specific offset of the neighboring cell. “Mp” may be defined as a measurement result of a Spcell (or serving cell) without considering any offsets, “Ofp” may be defined as a measurement object-specific offset of the Spcell (or serving cell), “Ocp” may be defined as a cell-specific offset of the Spcell (or serving cell), “Hys” may be defined as a hysteresis parameter for the event (e.g., the event “A3”), and “Off” may be defined as an offset parameter for the event. According to embodiments, “Of_a” may be defined as the assistance offset 142_1 for the event. “Mn” and “Mp” may be expressed in dBm units when measured based on RSRP and may be expressed in dB units when measured based on RSRQ and RS-SINR. In addition, “Ofn,” “Ocn,” “Ofp,” “Ocp,” “Hys,” “Off,” and “Of_a” may be in units of dB.

For example, under entering conditions “A5-1” and/or “A5-2” or leaving conditions “A5-3” and/or “A5-4”, which are related to the event “A5”, “Mp” may be defined as a measurement result of a new radio (NR) Spcell (or serving cell) without considering any offsets, “Mn” may be defined as a measurement result of a neighboring cell (or candidate cell) without considering any offsets, “Ofn” may be defined as a measurement object-specific offset of a reference signal of the neighboring cell (or the candidate cell), and “Ocn” may be defined as a cell-specific offset of the neighboring cell. “Hys” may be defined as a hysteresis parameter for the event (e.g., the “A5” event), and “Thresh1” and “Thresh2” may be defined as threshold parameters for the event. According to embodiments, “Of_a” may be defined as the assistance offset 142_1 for the event. “Mn” and “Mp” may be expressed in dBm units when measured based on RSRP and may be expressed in dB units when measured based on RSRQ and RS-SINR. In addition, “Ofn”, “Ocn”, “Hys”, and “Of_a” may be in units of dB.

According to embodiments, “Of_a” may include a parameter for changing the conditions for conditional handover as the assistance offset 142_1. For example, a range of values of “Of_a” may be preset (or alternatively, given) and a value may be determined within the range of values set by the user equipment.

According to embodiments, when “Of_a” has a positive value, the conditions for conditional handover related to the event “A3” may be relaxed as the entering condition “A3-1” is relaxed and/or the leaving condition “A3-2” is strengthened. In addition, when “Of_a” has a positive value, the conditions for conditional handover related to the event “A5” may be relaxed as the entering condition “A5-1” is relaxed and/or the leaving condition “A5-3” is strengthened.

According to embodiments, when “Of_a” has a negative value, the conditions for conditional handover related to the event “A3” may be strengthened as the entering condition “A3-1” is strengthened and/or the leaving condition “A3-2” is relaxed. In addition, when “Of_a” has a negative value, the conditions for conditional handover related to the event “A5” may be strengthened as the entering condition “A5-1” is strengthened and/or the leaving condition “A5-3” is relaxed.

According to embodiments, the user equipment may directly provide the assistance offset 142_1 to the serving cell, wherein the serving cell may adjust the conditions for conditional handover by using the assistance offset 142_1 as it is or may adjust the conditions for conditional handover after correcting the assistance offset 142_1.

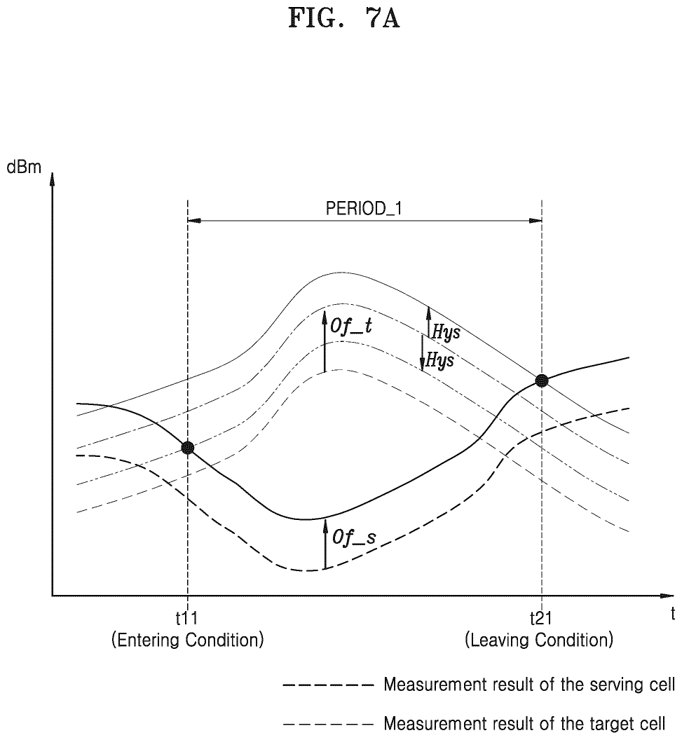

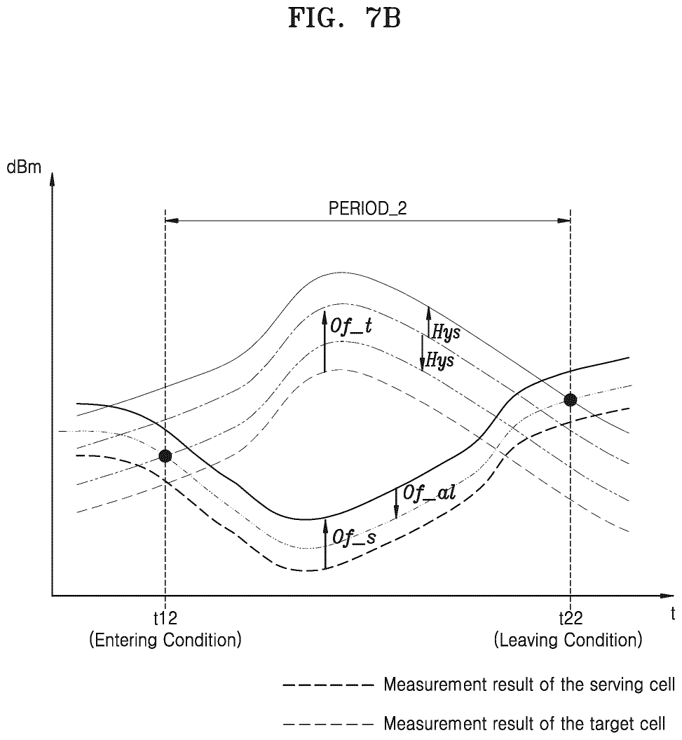

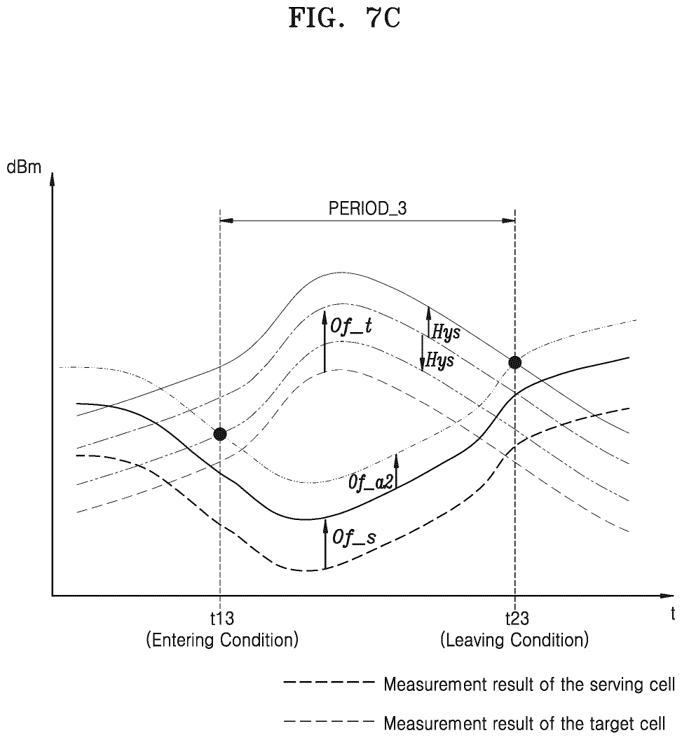

FIGS. 7A to 7C are diagrams specifically explaining examples of adjusting conditions for conditional handover related to an event “A3”, according to embodiments. FIG. 7A illustrates an example in which the assistance offset is not applied, FIG. 7B illustrates an example in which an assistance offset Of_a1 for relaxing the conditions for conditional handover is applied, and FIG. 7C illustrates an example in which an assistance offset Of_a2 for strengthening the conditions for conditional handover is applied.

Referring to FIG. 7A, the user equipment may compare a first operation result generated by adding a serving cell offset parameter “Of_s” (e.g., a parameter that is the sum of “Ofp”, “Ocp”, and “Off” in FIG. 6) to the measurement result of the serving cell (e.g., “Mp” in FIG. 6) with a second operation result generated by subtracting the hysteresis parameter “Hys” from the sum of the target cell offset parameter “Of_t” (e.g., a parameter that is the sum of “Ofn” and “Ocn” in FIG. 6) and the measurement result of the target cell (e.g., “Mn” in FIG. 6) to confirm that the entering condition is satisfied from the time “t11” at which the first operation result becomes smaller than the second operation result.

In addition, the user equipment may compare the first operation result with a third operation result generated by adding the measurement result of the target cell (e.g., “Mn” in FIG. 6) to the target cell offset parameter “Of_t” (e.g., a parameter which is the sum of “Ofn” and “Ocn” in FIG. 6) and the hysteresis parameter “Hys” to confirm that the leaving condition is satisfied from time “t21”, which is the time when the first operation result becomes greater than the third operation result.

As such, when the assistance offset is not applied, a period for which the entering condition is satisfied may correspond to a first period PERIOD_1.

Referring further to FIG. 7B, the user equipment may compare a fourth operation result generated by subtracting the assistance offset Of_a1 from the sum of the serving cell offset parameter “Of_s” (e.g., a parameter which is the sum of “Ofp”, “Ocp”, and “Off” in FIG. 6) and the measurement result of the serving cell (e.g., “Mp” in FIG. 6) with the second operation result generated by subtracting the hysteresis parameter “Hys” from the sum of the target cell offset parameter “Of_t” (e. g., a parameter which is the sum of “Ofn” and “Ocn” in FIG. 6) and the measurement result of the target cell to confirm that the entering condition is satisfied from the time “t12” at which the fourth operation result becomes smaller than the second operation result.

In addition, the user equipment may compare the fourth operation result with the third operation result generated by adding the target cell offset parameter “Of_t” (e.g., a parameter which is the sum of “Ofn” and “Ocn” in FIG. 6) and the hysteresis parameter “Hys” to the measurement result of the target cell (e.g., “Mn” in FIG. 6) to confirm that the leaving condition is satisfied from the time “t22” at which the fourth operation result becomes greater than the third operation result.

As described above, when the assistance offset Of_a1 is applied, a second period PERIOD_2, which is a period for which the entering condition is satisfied, may be greater than the first period PERIOD_1 in FIG. 7A. This means that the conditions for conditional handover have been relaxed.

With further reference to FIG. 7C, the user equipment may compare a fifth operation result generated by adding the serving cell offset parameter “Of_s” (e.g., a parameter which is the sum of “Ofp”, “Ocp”, and “Off” in FIG. 6) and the assistance offset Of_a2 to the measurement result of the serving cell (e.g., “Mp” in FIG. 6) with the second operation result generated by subtracting the hysteresis parameter “Hys” from the sum of the target cell offset parameter “Of_t” (e. g., a parameter which is the sum of “Ofn” and “Ocn” in FIG. 6) and the measurement result of the target cell (e.g., “Mn” in FIG. 6) to confirm that the entering condition is satisfied from the time “t13” at which the fifth operation result becomes smaller than the second operation result.

In addition, the user equipment may compare the fifth operation result with the third operation result generated by adding the target cell offset parameter “Of_t” (e.g., a parameter which is the sum of “Ofn” and “Ocn” in FIG. 6) and the hysteresis parameter “Hys” to the measurement result of the target cell (e.g., “Mn” in FIG. 6) to confirm that the leaving condition is satisfied from the time “t23” at which the fifth operation result becomes greater than the third operation result.

As described above, when the assistance offset OF_a2 is applied, a third period PERIOD_3, which is a period for which the entering condition is satisfied, may be less than the first period PERIOD_1 in FIG. 7A. This means that the conditions for conditional handover are strengthened.

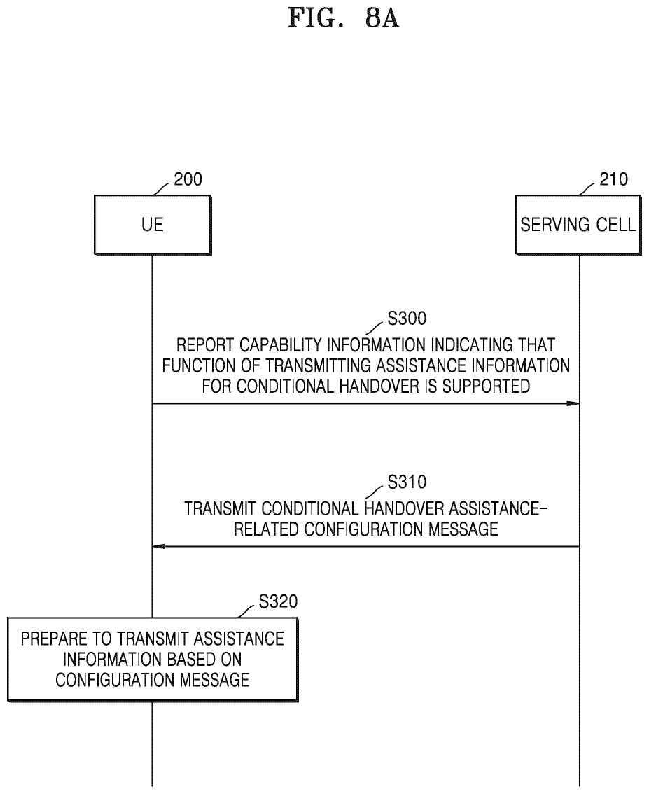

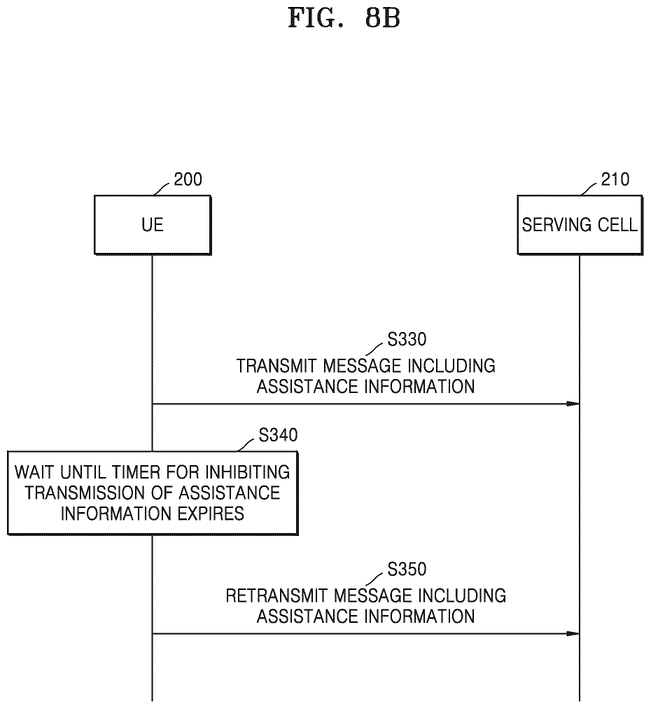

FIGS. 8A and 8B are flowcharts of a method of transmitting assistance information, according to embodiments.

Referring to FIG. 8A, in operation S300, user equipment 200 may report capability information indicating that a function of transmitting the assistance information for conditional handover is supported (e.g., may transmit an indication that the user equipment 200 is capable of transmitting the assistance information) to a serving cell 210. According to embodiments, the user equipment 200 may perform a procedure for RRC connection with the serving cell 210 and may transmit, to the serving cell 210, the capability information indicating that the function of transmitting the assistance information is supported. In embodiments, UE assistance information (UAI) defined in 3GPP TS 38.331 may include the assistance information for adjusting the conditions for conditional handover. The user equipment 200 may report, to the serving cell 210, the capability information indicating that the assistance information for adjusting the conditions for conditional handover may be transmitted through a message including the UAI.

In operation S310, the serving cell 210 may transmit a conditional handover assistance-related configuration message based on the reported capability information. For example, the conditional handover assistance-related configuration message may correspond to a “CHOAssistanceConfig” message defined in the 3GPP standard. The serving cell 210 may notify the user equipment 200 that the assistance information may be reported to the serving cell through the conditional handover assistance-related configuration message and may provide information for parameter configuration of the user equipment 200, which is necessary (or used) for transmitting the assistance information. According to embodiments, the conditional handover assistance-related configuration message may include information about a timer for inhibiting transmission of the assistance information. The timer for inhibiting transmission of the assistance information starts at a time point when the user equipment 200 transmits a message including the assistance information, wherein the transmission of the message including the assistance information may be prohibited (or delayed, retrained, etc.) until the timer for inhibiting transmission of the assistance information expires. As a specific example, the information about the timer for inhibiting transmission of the assistance information may include information indicating an expiration time of the timer for inhibiting transmission of the assistance information.

In operation S320, the user equipment 200 may prepare to transmit the assistance information based on the conditional handover assistance-related configuration message. According to embodiments, the user equipment 200 may confirm the information about the timer for inhibiting transmission of the assistance information included in the conditional handover assistance-related configuration message to set a parameter (e.g., a parameter about then expiration time) related to the timer for inhibiting transmission of the assistance information.

With further reference to FIG. 8B, in operation S330, the user equipment 200 may transmit the message including the assistance information to the serving cell 210. For example, the message may correspond to a “CHOAssistanceInformation” message defined in the 3GPP standard. The user equipment 200 may initiate the timer for inhibiting transmission of the assistance information, which was set in operation S320. According to embodiments, the assistance information may include an assistance offset. For example, the value of the assistance offset may have any value within a preset (or alternatively, given) range of values.

In operation S340, the user equipment 200 may wait until the timer for inhibiting transmission of the assistance information expires.

In operation S350, the user equipment 200 may retransmit the message including the assistance information when a response (or an ACK) to the message including the assist information is not (e.g., has not been) received from the serving cell 210.

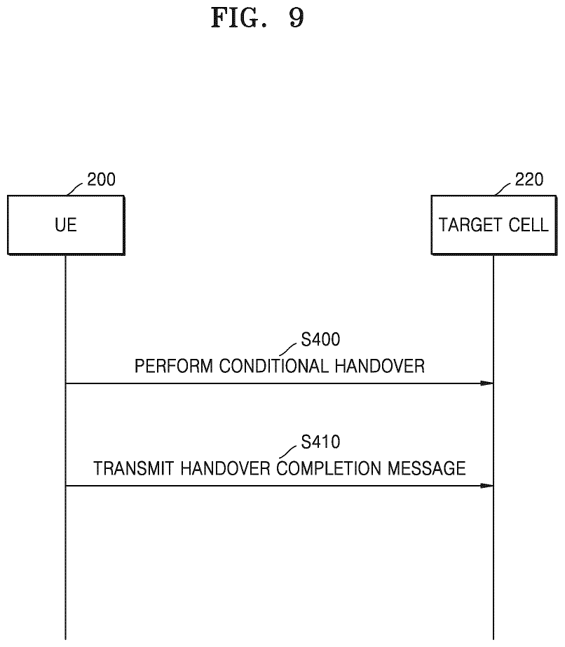

FIG. 9 is a flowchart of a method of transmitting assistance information, according to embodiments.

Referring to FIG. 9, in operation S400, user equipment 200 and a target cell 220 may perform conditional handover. The conditional handover may include operations for connecting to the target cell 220 when the user equipment 200 evaluates the conditions for conditional handover and determines that the conditions are satisfied. According to embodiments, the user equipment 200 may determine to transmit the assistance information to smoothly perform future conditional handover in a process of performing previous conditional handover with the serving cell.

In operation S410, the user equipment 200 may transmit a handover completion message (e.g., a conditional handover completion message) including the assistance information to the target cell 220. For example, the handover completion message may correspond to an “RRC ReconfigurationComplete” message defined in the 3GPP standard. According to embodiments, the assistance information may include an assistance offset.

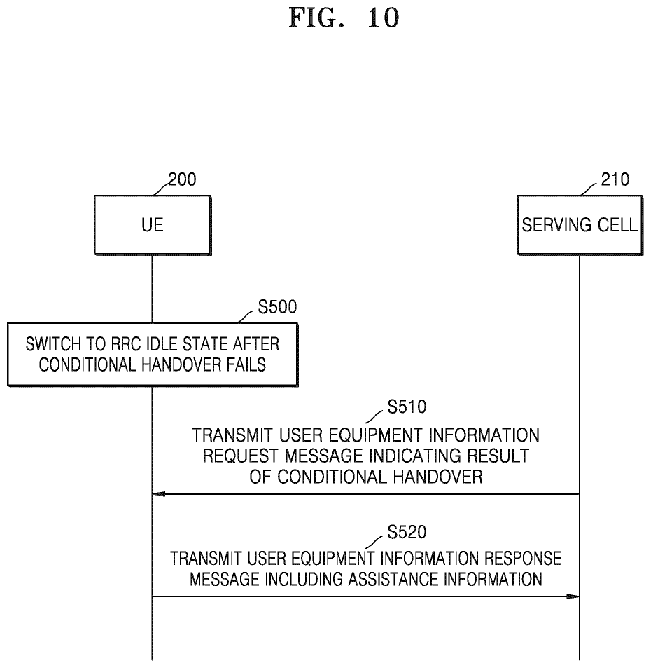

FIG. 10 is a flowchart of a method of transmitting assistance information, according to embodiments.

Referring to FIG. 10, in operation S500, the user equipment 200 may be switched to an RRC idle state after the conditional handover fails. For example, when the user equipment 200 evaluates the conditions for conditional handover and determines that the conditions are not satisfied, the conditional handover may fail and the user equipment 200 may switch to the RRC idle state.

In operation S510, the serving cell 210 may transmit a user equipment information request message indicating the result of the conditional handover (e.g., requesting an indication of the result of the conditional handover). For example, the user equipment information request message may correspond to a “UEInformationRequest” message defined in the 3GPP standard. The serving cell 210 may request the result of the conditional handover to the user equipment 200 in the RRC idle state via the user equipment information request message.

In operation S520, the user equipment 200 may transmit a user equipment information response message including the assistance information to the serving cell 210. For example, the user equipment information response message may correspond to a “UEInformationResponse” message defined in the 3GPP standard, wherein the “UEInformationResponse” message includes a “failedHO-Report-rlx” message defined to inform failure of conditional handover, wherein the “failedHO-Report-rlx” message may include the assistance information. According to embodiments, the assistance information may include an assistance offset.

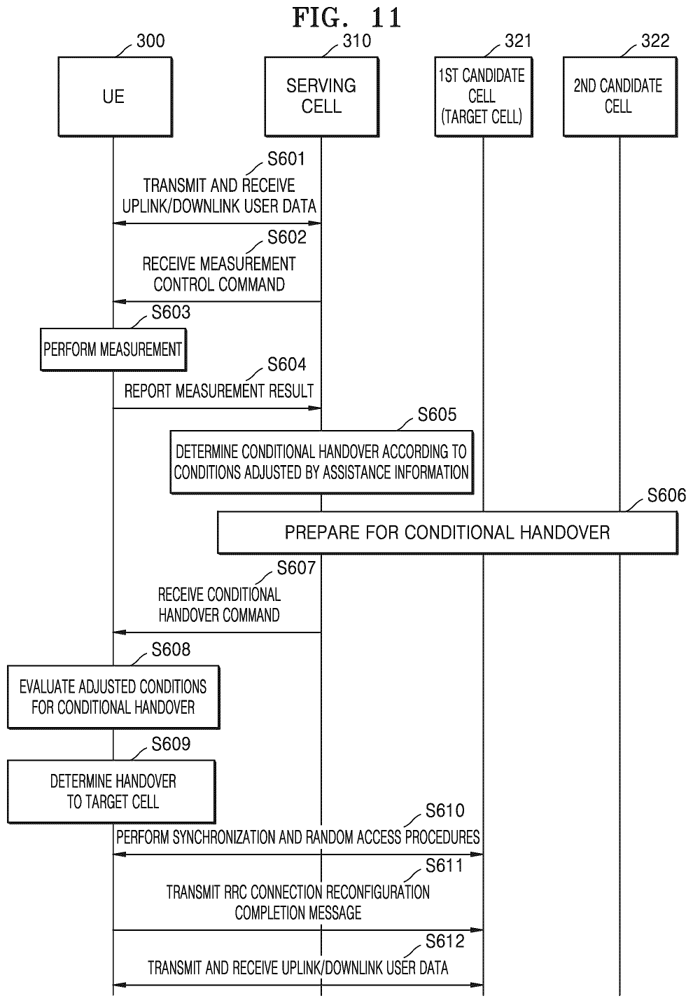

FIG. 11 is a flowchart of a conditional handover operation according to embodiments. In FIG. 11, it is assumed that a first candidate cell 321 and a second candidate cell 322 include cells adjacent to the serving cell 310 and cells which are candidates of the target cell, wherein the first candidate cell 321 is the target cell.

Referring to FIG. 11, in operation S601, the user equipment 300 may transmit and receive uplink/downlink user data to and from the serving cell 310.

In operation S602, the user equipment 300 may receive a measurement control command from the serving cell 310.

In operation S603, the user equipment 300 may measure signals received from the first candidate cell 321 and the second candidate cell 322 which are adjacent to the serving cell 310 based on the received measurement control command.

In operation S604, the user equipment 300 may report the measurement result to the serving cell 310.

In operation S605, the serving cell 310 may determine the conditional handover according to the conditions adjusted by the assistance information based on the reported measurement result. According to embodiments, the serving cell 310 may receive the assistance information from the user equipment 300 in advance and the conditions for conditional handover may be relaxed or strengthened based on the assistance information.

In operation S606, the serving cell 310 may prepare for conditional handover with the first candidate cell 321 and the second candidate cell 322. As a specific example, the serving cell 310 may determine the first candidate cell 321 and the second candidate cell 322 that may potentially be target cells among cells adjacent to the serving cell 310 based on the reported measurement result. The serving cell 310 may transmit a handover request message to each of the first candidate cell 321 and the second candidate cell 322. The handover request message may include information indicating that the handover is conditional handover. The first candidate cell 321 and the second candidate cell 322 may determine to accept a handover request and internally allocate internal resources for handover with the user equipment 300. Thereafter, the first candidate cell 321 and the second candidate cell 322 may transmit a handover request ACK message to the serving cell 210. The handover request ACK message may include radio configuration information allocated for handover of the user equipment 300 by the first candidate cell 321 and the second candidate cell 322.

In operation S607, the user equipment 300 may receive a conditional handover command from the serving cell 310. According to embodiments, the conditional handover command may include the information indicating the conditions adjusted by the assistance information (or information indicating that the assistance information is reflected) and the radio configuration information of the first candidate cell 321 and the second candidate cell 322. In embodiments, the conditional handover command may be referred to as an RRC connection reconfiguration message.

In operation S608, the user equipment 300 may maintain the connection with the serving cell 310 and may measure the signals received from the first candidate cell 321 and the second candidate cell 322 to evaluate the adjusted conditions for conditional handover.

In operation S609, the user equipment 300 may confirm that the first candidate cell 321 satisfies the adjusted conditions for conditional handover, determine the first candidate cell 321 as the target cell, and determine handover to the target cell 321.

In operation S610, the user equipment 300 may perform synchronization and random access procedures with the target cell 321.

In operation S611, when the user equipment 300 succeeds in operation S610, the user equipment 300 may transmit an RRC connection reconfiguration completion message to the target cell 321.

In operation S612, the user equipment 300 may transmit and receive the uplink/downlink user data with the connected target cell 321 through conditional handover. According to embodiments, the user equipment 300 may generate a first signal (e.g., using the processor 130), process the first signal to perform one or more among modulating, upconverting, filtering, amplifying and/or encrypting on the first signal (e.g., using the RF integrated circuit 120), and transmit the processed first signal to the connected target cell 321 via one or more of the plurality of antennas 110. Additionally or alternatively, the user equipment 300 may receive a second signal from the connected target cell 321 via the one or more of plurality of antennas 110, process the second signal to perform one or more among demodulating, downconverting, filtering, amplifying and/or decrypting on the second signal (e.g., using the RF integrated circuit 120), and perform a further operation(s) (e.g., using the processor 130) based on the processed second signal. For example, the further operation(s) may include one or more of providing the processed second signal to a corresponding application executing on the user equipment 300, storing the processed second signal (e.g., in the memory 140), sending a response signal to the connected target cell 321 (e.g., based on a processing result of the corresponding application executing on the user equipment 300), etc.

Also, the target cell 321 may notify that the user equipment 300 has successfully completed handover to the target cell 321 by transmitting a handover completion message (e.g., a conditional handover completion message) to the serving cell 310. The serving cell 310 may, in response thereto, transmit a handover cancellation message to the second candidate cell 322.

The user equipment 300, according to embodiments, may provide the assistance information to the serving cell 310 in advance for smooth handover and the serving cell 310 may adjust the conditions for conditional handover based on the assistance information.

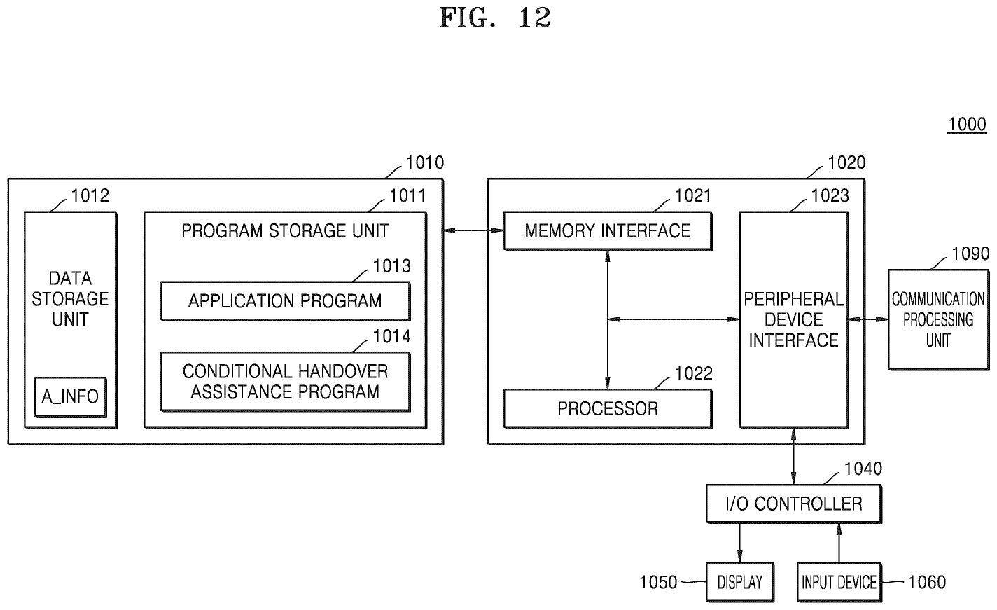

FIG. 12 is a block diagram of an electronic device 1000 according to embodiments.

Referring to FIG. 12, the electronic device 1000 may include a memory 1010, a processor unit 1020, an input/output (I/O) controller 1040, a display 1050, an input device 1060, and/or a communication processing unit 1090. There may be a plurality of memories 1010. Each component is described in detail below.

The memory 1010 may include a program storage unit 1011 that stores programs for controlling operation of electronic devices and a data storage unit 1012 that stores data generated during program execution. The data storage unit 1012 may store data necessary (or used) for operating an application program 1013 and a conditional handover assistance program 1014. The data storage unit 1012 may store assistance information A_INFO according to embodiments.

The program storage unit 1011 may include the application program 1013 and/or the conditional handover assistance program 1014. The programs included in the program storage unit 1011 may be represented by an instruction set as a set of instructions. The application program 1013 may include program codes for executing various applications operating on the electronic device 1000. That is, the application program 1013 may include codes (or commands) relating to various applications driven by a processor 1022. The conditional handover assistance program 1014 may include control codes for performing an operation of determining to transmit the assistance information and an operation of generating the assistance information, according to embodiments.

According to embodiments, the processor 1022 may determine, by executing the conditional handover assistance program 1014, whether to transmit the assistance information based on the reception performance of the electronic device 1000 or the history of previous conditional handover and may generate the assistance information.

The electronic device 1000 may include a communication processing unit 1090 that performs communication functions for voice communication and data communication. The processor 1022 may perform an operation for conditional handover with the serving cell or the target cell through the communication processing unit 1090. In addition, the processor 1022 may include the assistance information in a message defined in the standard of 3GPP to transmit the message to the serving cell through the communication processing unit 1090.

A peripheral device interface 1023 may control the connection between the I/O controller 1040, the communication processing unit 1090, the processor 1022, and/or a memory interface 1021. The processor 1022 controls the plurality of cells by using at least one software program to provide the corresponding service. The processor 1022 may execute at least one program stored in the memory 1010 to provide a service corresponding to the program.

The I/O controller 1040 may provide an interface between an I/O device, such as the display 1050 and/or the input device 1060, and the peripheral device interface 1023. The display 1050 displays state information, input characters, moving pictures, still pictures, and the like. For example, the display 1050 may display application program information, driven by the processor 1022.

The input device 1060 may provide input data generated by selection of the electronic device 1000 to the processor unit 1020 through the I/O controller 1040. The input device 1060 may include a keypad including at least one hardware button, a touchpad for sensing touch information, and the like. For example, the input device 1060 may provide touch information, such as touch, touch movement, and touch release, detected by the touchpad to the processor 1022 through the I/O controller 1040.

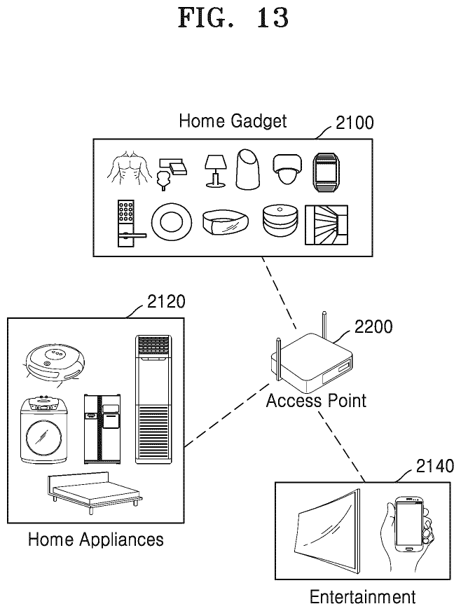

FIG. 13 is a diagram of communication devices performing a conditional handover operation according to embodiments.

Referring to FIG. 13, a home gadget 2100, home appliances 2120, an entertainment device 2140, and/or an AP 2200 may perform a handover operation, according to embodiments. A plurality of APs 2200 may be respectively located at various points. The home gadget 2100, the home appliances 2120, and/or the entertainment device 2140 may perform the conditional handover, according to embodiments, from one of the plurality of APs 2200 to another.

In embodiments, the home gadget 2100, the home appliances 2120, the entertainment device 2140, and/or the AP 2200 may constitute an Internet of Things (IoT) network system. It will be understood that the communication devices shown in FIG. 13 are merely examples and other communication devices not shown in FIG. 13 may also include a wireless communication device, according to embodiments.

Conventional devices and methods for performing a conditional handover involve a serving cell providing a user equipment (UE) with first conditions for performing the conditional handover, where the first conditions are based on favorable channel conditions between the serving cell and the UE. However, in scenarios in which current and/or actual channel conditions between the serving cell and the UE are better or worse than those on which the first conditions are based, the performance of the conditional handover is not performed effectively or is inefficient. For example, in a scenario in which the current and/or actual channel conditions are worse, the conditional handover is not performed resulting in a failed handover and excessive data loss. Also, in a scenario in which current and/or actual channel conditions are better, the conditional handover is excessive resulting in resource wastage (e.g., power, processor, bandwidth, delay, etc.).

However, according to embodiments, improved devices and methods are provided for performing a conditional handover. For example, the improved devices and methods may involve the UE determining assistance information based on a reception performance of the UE and/or a handover history, and the serving cell adjusting the first conditions based on the assistance information. Accordingly, the conditional handover may be performed more readily in scenarios in which the current and/or actual channel conditions are worse, and less readily in scenarios in which the current and/or actual channel conditions are better. Therefore, the improved devices and methods improve over the conventional devices and methods to at least reduce data loss and/or resource wastage.

According to embodiments, operations described herein as being performed by the communication system 1, each of plurality of macro cells MC1 to MC4, each of the plurality of small cells SC1 to SC7, the user equipment 100, the RF integrated circuit 120, the processor 130, the handover assistance circuit 132, the serving cell 10, the user equipment 200, the serving cell 210, the target cell 220, the user equipment 300, the serving cell 310, the first candidate cell 321, the second candidate cell 322, the electronic device 1000, the processor unit 1020, the I/O controller 1040, the communication processing unit 1090, the peripheral device interface 1023, the processor 1022, the memory interface 1021, the home gadget 2100, each of the home appliances 2120, the entertainment device 2140, and/or the AP 2200 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 140, the memory 1010, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

While the inventive concepts have been particularly shown and described with reference to embodiments thereof, it will be understood that various changes in form and details may be made therein without departing from the spirit and scope of the following claims.

What is claimed is:

1. An operation method of user equipment, the operation method comprising:
transmitting a first message including assistance information to a serving cell based on a determination, the assistance information corresponding to a conditional handover;
receiving a conditional handover-related message indicating adjusted first conditions, the adjusted first conditions having been adjusted from first conditions based on the assistance information, and the first conditions being conditions for performing a conditional handover;
evaluating the adjusted first conditions to obtain an evaluation result; and
performing the conditional handover with a target cell based on the evaluation result.

2. The operation method of claim 1, further comprising:
generating an index value of reception performance by measuring a data reception rate and a received signal strength; and
determining to perform the transmitting based on the index value.

3. The operation method of claim 2, wherein the data reception rate comprises at least one of a data error rate or a data throughput.

4. The operation method of claim 2, further comprising:
determining to perform the transmitting based on the index value being less than a threshold corresponding to the received signal strength.

5. The operation method of claim 1, further comprising:
analyzing an evaluation-related history of at least one previous conditional handover to obtain an analysis result;
determining whether the analysis result satisfies an assistance condition to obtain a determination result; and
determining to perform the transmitting based on the determination result.

6. The operation method of claim 1, further comprising:
selecting one of relaxing or strengthening of the first conditions to obtain a selection result; and
generating the assistance information based on the selection result.

7. The operation method of claim 1, wherein the assistance information comprises information to relax or strengthen the first conditions.

8. The operation method of claim 1, wherein the assistance information comprises an assistance offset applied to the first conditions.

9. The operation method of claim 1, further comprising:
reporting capability information to the serving cell, the capability information indicating support for a function of transmitting the assistance information;
receiving a conditional handover assistance-related configuration message based on the capability information from the serving cell; and
preparing to transmit the first message based on the conditional handover assistance-related configuration message.

10. The operation method of claim 9, wherein the conditional handover assistance-related configuration message comprises information about a timer for inhibiting transmission of the first message.

11. The operation method of claim 1, wherein the first message comprises a conditional handover completion message transmitted from a previous cell to the serving cell.

12. The operation method of claim 1, wherein the first message comprises a user equipment information response message in response to a user equipment information request message indicating a previous conditional handover result.

13. An operation method of a serving cell, the operation method comprising:
receiving a first message including assistance information from user equipment, the assistance information corresponding to a conditional handover;
adjusting first conditions based on the assistance information to obtain adjusted first conditions, the first conditions being conditions for performing a conditional handover; and
transmitting a conditional handover-related message indicating the adjusted first conditions.

14. The operation method of claim 13, wherein the assistance information comprises an assistance offset applied to the first conditions.

15. The operation method of claim 14, wherein the adjusting of the first conditions comprises:
correcting the assistance offset to obtain a corrected assistance offset; and
relaxing or strengthening the conditions for conditional handover based on the corrected assistance offset.

16. The operation method of claim 13, further comprising:
receiving capability information from the user equipment, the capability information indicating support for a function of transmitting the assistance information; and
transmitting, to the user equipment, a conditional handover assistance-related configuration message based on the capability information, the conditional handover assistance-related configuration message including a timer for inhibiting transmission of the first message.

17. The operation method of claim 13, wherein the first message comprises a conditional handover completion message transmitted from a previous cell to the serving cell.

18. The operation method of claim 13, further comprising:
transmitting a user equipment information request message to the user equipment, the user equipment information request message indicating a previous conditional handover result, the first message including a user equipment information response message in response to the user equipment information request message.

19. User equipment comprising:
memory configured to store assistance information for relaxing or strengthening conditions for conditional handover; and
a processor configured to determine whether to transmit the assistance information to a serving cell based on an index value of reception performance, the index value being generated by measuring a data reception rate and a received signal strength from signals received from the serving cell.

20. The user equipment of claim 19, wherein the assistance information is included in one of a plurality of messages transmitted from the user equipment to the serving cell, the plurality of messages being defined in 3rd generation partnership project (3GPP) technical specification (TS) 38.331.
